(19) United States
(12) Patent Application Publication
(10) Pub. No.: US 2025/0374213 A1
(43) Pub. Date: Dec. 4, 2025

(54) SIDELINK-UNLICENSED WIDEBAND RESOURCE POOL CONFIGURATION FOR COMMUNICATIONS

(71) Applicant: QUALCOMM Incorporated, San Diego, CA (US)

(72) Inventors: Chih-Hao LIU, San Diego, CA (US); Jing SUN, San Diego, CA (US); Giovanni CHISCI, San Diego, CA (US); Stelios STEFANATOS, San Diego, CA (US); Yisheng XUE, San Diego, CA (US); Xiaoxia ZHANG, San Diego, CA (US)

(21) Appl. No.: 18/876,135

(22) PCT Filed: Aug. 1, 2023
(86) PCT No.: PCT/US2023/071418

§ 371 Date: Dec. 17, 2024

(30) Foreign Application Priority Data
Aug. 8, 2022 (GR) 20220100665

(51) Int. Cl. H04W 56/00; H04L 1/1607; H04W 72/02; H04W 72/25; H04W 74/0816; H04W 92/18

(52) U.S. Cl. CPC H04W 56/0015; H04L 1/1614; H04W 72/02; H04W 72/25; H04W 74/0816; H04W 92/18

(57) ABSTRACT

The described techniques relate to improved methods, systems, devices, and apparatuses that support sidelink synchronization signal block (S-SSB) designs with wideband resource pool for data transmissions within a shared spectrum. For example, the described techniques provide for a user equipment (UE) to transmit one or more S-SSBs within one or more sub-band(s) of a slot such that the remaining bandwidth, including within the same slot as the S-SSB remain available in the resource pool for data communication. The techniques provided in the present disclosure allow for greater utilization of the bandwidth with minimal resource blocks that are omitted from utilization in the shared spectrum. Such implementation, therefore, maximizes the shared spectrum utilization.

### CROSS-REFERENCE TO RELATED APPLICATIONS

This application is a national stage application filed under 35 U.S.C. 371 based on International Patent Application No. PCT/US2023/071418 entitled SIDELINK-UNLICENSED WIDEBAND RESOURCE POOL CONFIGURATION FOR COMMUNICATIONS, and filed on Aug. 1, 2023 which claims the benefit of Greek Patent Application No. 20220100665, entitled SIDELINK-UNLICENSED WIDEBAND RESOURCE POOL CONFIGURATION FOR COMMUNICATIONS, and filed on Aug. 8, 2022, both of which are expressly incorporated by reference herein in their entireties.

### BACKGROUND

### Technical Field

The present disclosure generally relates to communication systems, and more particularly, to implementing sidelink-u wideband resource pool configuration in consideration with sidelink-synchronization signal block (S-SSB) designs for shared spectrum.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

Some wireless communications systems may support communications between user equipments (UEs), which may be referred to as sidelink communications. In some examples, however, some sidelink signaling transmitted between UEs may be incompatible with or fail to satisfy some requirements (e.g., occupied channel bandwidth (OCB) requirements), such as for communications in shared spectrum.

Therefore, there exists a need for further improvements in 5G NR technology. These improvements may also be applicable to other multi-access technologies and the telecommunication standards that employ these technologies. For instance, improvements to efficiency and latency relating to mobility of UEs communicating with network entities are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The described techniques relate to improved methods, systems, devices, and apparatuses that support sidelink synchronization signal block (S-SSB) designs with wideband resource pool for data transmissions within a shared spectrum. For example, the described techniques provide for a user equipment (UE) to transmit one or more S-SSBs within one or more sub-band(s) of a slot such that the remaining bandwidth, including within the same slot as the S-SSB remain available in the resource pool for data communication. The techniques provided in the present disclosure allow for greater utilization of the bandwidth with minimal resource blocks that are omitted from utilization in the shared spectrum. Such implementation, therefore, increases the shared spectrum utilization.

In an example aspect includes a method of wireless communication by a user equipment, comprising configuring resources to support sidelink communication between a first user equipment (UE) and a second UE over a shared spectrum such that at least a first set of resource blocks (RBs) within a first sub-band of a first transmission time interval (TTI) are available to be part of a resource pool for sidelink data communication and a second set of RBs within a second sub-band of the first TTI are allocated to allow for transmission of sidelink synchronization signal block (S-SSB). The method may further include transmitting, from the first UE to the second UE, one or more S-SSBs in the second set of RBs within the second sub-band of the first TTI that are allocated for S-SSB transmissions while the first set of RBs within the first sub-band of the first TTI are included within the resource pool for one or more UEs to utilize for data communications over the shared spectrum.

Another example aspect includes an apparatus for wireless communication by a user equipment, comprising a memory that includes instructions executable by a processor coupled with the memory. The instructions executable by the processor to configure resources to support sidelink communication between a first UE and a second UE over a shared spectrum such that at least a first set of RBs within a first sub-band of a first TTI are available to be part of a resource pool for sidelink data communication and a second set of RBs within a second sub-band of the first TTI are allocated to allow for transmission of S-SSB. The processor is further configured to transmit, from the first UE to the second UE, one or more S-SSBs in the second set of RBs within the second sub-band of the first TTI that are allocated for S-SSB transmissions while the first set of RBs within the first sub-band of the first TTI are included within the resource pool for one or more UEs to utilize for data communications over the shared spectrum.

Another example includes an apparatus for wireless communication by a user equipment, comprising means for configuring resources to support sidelink communication between a first UE and a second UE over a shared spectrum such that at least a first set of RBs within a first sub-band of a first TTI are available to be part of a resource pool for sidelink data communication and a second set of RBs within a second sub-band of the first TTI are allocated to allow for transmission of S-SSB. The apparatus further include means for transmitting, from the first UE to the second UE, one or more S-SSBs in the second set of RBs within the second sub-band of the first TTI that are allocated for S-SSB transmissions while the first set of RBs within the first sub-band of the first TTI are included within the resource pool for one or more UEs to utilize for data communications over the shared spectrum.

Another example includes a non-transitory computer readable medium storing instructions, executable by a processor, for wireless communications. The instructions, executable by the processor, include instructions for configuring resources to support sidelink communication between a first UE and a second UE over a shared spectrum such that at least a first set of RBs within a first sub-band of a first TTI are available to be part of a resource pool for sidelink data communication and a second set of RBs within a second sub-band of the first TTI are allocated to allow for transmission of S-SSB. The processor further includes instructions for include means for transmitting, from the first UE to the second UE, one or more S-SSBs in the second set of RBs within the second sub-band of the first TTI that are allocated for S-SSB transmissions while the first set of RBs within the first sub-band of the first TTI are included within the resource pool for one or more UEs to utilize for data communications over the shared spectrum.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network in accordance with various aspects of the present disclosure.

FIG. 1B is a diagram illustrating an example of disaggregated base station architecture, in accordance with various aspects of the present disclosure.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating frame structure, resources, and channels that support the use of an S-SSB waveform in configuration with wideband resource pool in order to reduce and/or minimize S-SSB slot avoidance and increase and/or maximize resource pool utilization

FIG. 4A is a first example of frame structure, resources, and channels that support the use of an S-SSB waveform in configuration with wideband resource pool.

FIG. 4B is a second example of frame structure, resources, and channels that support the use of an S-SSB waveform in configuration with wideband resource pool.

FIG. 4C is a third example of frame structure, resources, and channels that support the use of an S-SSB waveform in configuration with wideband resource pool.

FIG. 4D is a fourth example of frame structure, resources, and channels that support the use of an S-SSB waveform in configuration with wideband resource pool.

FIG. 5 is a schematic diagram of an example implementation of various components of a user equipment in accordance with various aspects of the present disclosure.

FIG. 6 is a flow diagram of an example of a method of wireless communication implemented by the UE in accordance with aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Some wireless communications systems may support sidelink communications between user equipments (UEs). In some cases, a UE may communicate using one or more frequency bands associated with a shared radio frequency spectrum, which may be referred to as unlicensed radio frequency spectrum bands. The shared spectrum may include radio frequency bands, which may not be reserved, allocated, or licensed for specific use cases or specific radio access technologies (RATs). In such systems, a UE may perform a listen-before-talk (LBT) procedure to gain access to a sidelink bandwidth part (BWP) for a sidelink transmission. In some cases, the UE may use signaling that satisfies an occupied channel bandwidth (OCB) threshold associated with shared spectrum transmissions. In some cases, the OCB threshold for shared spectrum communications may be specified in a wireless communications standard. The OCB threshold may include a threshold percentage of a channel to be occupied or used for wireless communications (e.g., 80% of a 20 megahertz (MHz) channel).

In some cases, the UE may gain access to the sidelink BWP to transmit sidelink synchronization signal blocks (S-SSBs). The S-SSBs may allow other UEs to discover the UE and establish a sidelink connection with the UE for subsequent sidelink communications. In some examples, the discovery reference signal (DRS) window may include multiple S-SSB candidate locations to increase opportunities for the UE to transmit S-SSB. However the increase in the SSB opportunities may adversely impact overall resource pool for data communications on the shared spectrum. Conventional resource pools typically exclude transmitting data in the same time slot as the S-SSB signal. Such general exclusion of S-SSB slots from resource pools may impact bandwidth utilization and transmissions reliability. For example, if the data channel occupancy time (COT) transmission (e.g., for continuous transmission) falls across S-SSB occasions, but the UE does not transmit S-SSB during the S-SSB occasion, the COT may be terminated prematurely. Thus, where there are multiple S-SSB candidate slots or positions, the overhead of S-SSB may be significant and adversely impact the throughput for data communications, particularly for eMBB traffic.

In some aspects, including the S-SSB transmission in the data resource pool may be beneficial where the PSCCH and/or PSSCH transmission could rate match around the S-SSB in the same slot. For example, a UE may use a waveform for S-SSBs, such that the S-SSBs are transmitted using time-frequency resources that enable the UE to multiplex the S-SSBs with PSSCH signaling in a frequency domain. As an example, the UE may transmit the one or more S-SSBs using four symbols of a slot (e.g., a 14-symbol slot), and the one or more S-SSBs may be sent using four symbols that are different from the first four symbols of the slot (e.g., to avoid time-frequency resources allocated for PSCCH signaling). In some cases, the UE may transmit sidelink control information (SCI), which may indicate which sub-bands are carrying the S-SSBs. The SCI may indicate the one or more sub-bands via a bitmap, a sub-band index field, a single bit, or any combination thereof. The UE may select time-frequency resources for the one or more S-SSBs to avoid time-frequency resources for PSCCH signaling, demodulation reference signal (DMRS) signaling, SCI signaling, and automatic gain control (AGC) signaling. Additionally, or alternatively, the UE may perform one or more operations to maintain phase continuity and limit transmit power variation. For example, the one or more operations may include any combination of transmitting PSCCH and PSSCH signaling using an interlace waveform design, adjusting a transmit power for PSSCH signaling, performing rate matching around the S-SSB symbols, and transmitting shortened PSSCH signaling.

However, multiplexing the PSCCH and/or PSSCH and S-SSB in the same slot presents its own shortcomings. For example, not all UEs or service providers may be adaptable to multiplex the PSCCH and/or PSSCH and S-SSB in the same slot. Additionally, having subchannel rate matching around S-SSB REs implies un-equal size of subchannels in S-SSB slots and the resource mapping. Thus, the resource selection and reservation may be more complicated. In some use cases, for example vehicle-to-everything (V2X), where the coverage is of a concern, S-SSB SFN transmission and/or power boosting may also be required. Thus, a multiplexed PSCCH and/or PSSCH with S-SSB signal may not be a practical solution in a host of scenarios.

In accordance with the techniques described herein, a UE may transmit one or more S-SSBs within one or more sub-band(s) of a slot such that the remaining bandwidth, including within the same slot as the S-SSB remain available in the resource pool for data communication. In some examples, the sidelink-unlicensed band may be configured with wideband operation (e.g., 100 MHz). As such, the exclusion of all RB-sets in S-SSB slot from resource pool may be avoided by the UEs. The techniques provided in the present disclosure allow for greater utilization of the bandwidth with minimal resource blocks that are omitted from utilization in the shared spectrum. Such implementation, therefore, increases and/or maximizes the shared spectrum utilization.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUS), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

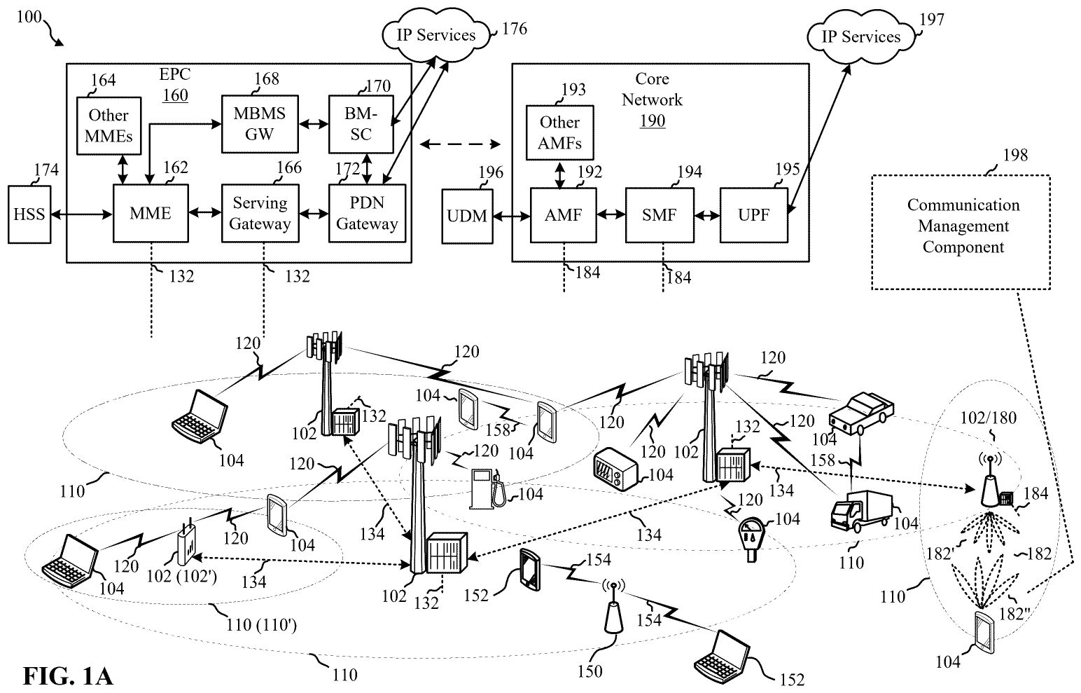

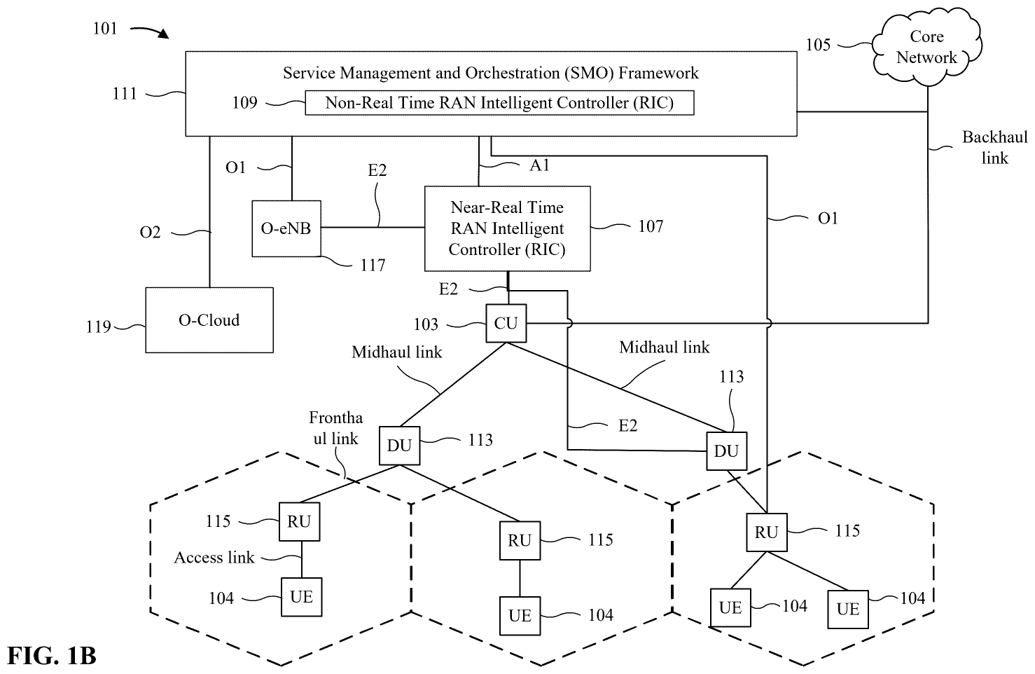

FIG. 1A is a diagram illustrating an example of a wireless communications system 100 (also referred to as a wireless wide area network (WWAN)) that includes base stations 102 (also referred to herein as network entities), user equipment(s) (UE) 104, an Evolved Packet Core (EPC) 160, and another core network 190 (e.g., a 5G Core (5GC)).

One or more of the UEs 104 may include a communication management component 198, wherein the communication management component 198 is operable to perform techniques for configuring the UE communications within the sidelink-unlicensed band for wideband operation such that a UE may transmit one or more S-SSBs within one or more sub-band(s) of a slot without imposing exclusion of all RB-sets in S-SSB slot from resource pool.

The base stations (or network entities) 102 may include macrocells (high power cellular base station) and/or small cells (low power cellular base station). The macrocells include base stations. The small cells include femtocells, picocells, and microcells. The base stations 102 can be configured in a Disaggregated RAN (D-RAN) or Open RAN (O-RAN) architecture, where functionality is split between multiple units such as a central unit (CU), one or more distributed units (DUs), or a radio unit (RU). Such architectures may be configured to utilize a protocol stack that is logically split between one or more units (such as one or more CUs and one or more DUs). In some aspects, the CUs may be implemented within an edge RAN node, and in some aspects, one or more DUs may be co-located with a CU, or may be geographically distributed throughout one or multiple RAN nodes. The DUs may be implemented to communicate with one or more RUs. Any of the disaggregated components in the D-RAN and/or O-RAN architectures may be referred to herein as a network entity.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a network entity, gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, monitors, cameras, industrial/manufacturing devices, appliances, vehicles, robots, drones, etc.). IoT UEs may include machine type communications (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

FIG. 1B is a diagram illustrating an example of disaggregated base station 101 architecture, any component or element of which may be referred to herein as a network entity. The disaggregated base station 101 architecture may include one or more central units (CUs) 103 that can communicate directly with a core network 105 via a backhaul link, or indirectly with the core network 105 through one or more disaggregated base station units (such as a Near-Real Time (Near-RT) RAN Intelligent Controller (RIC) 107 via an E2 link, or a Non-Real Time (Non-RT) RIC 109 associated with a Service Management and Orchestration (SMO) Framework 111, or both). A CU 103 may communicate with one or more distributed units (DUs) 113 via respective midhaul links, such as an F1 interface. The DUs 113 may communicate with one or more radio units (RUs) 115 via respective fronthaul links. The RUs 115 may communicate with respective UEs 104 via one or more radio frequency (RF) access links. In some implementations, the UE 104 may be simultaneously served by multiple RUs 115.

Each of the units, e.g., the CUS 103, the DUs 113, the RUs 115, as well as the Near-RT RICs 107, the Non-RT RICs 109 and the SMO Framework 111, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 103 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 103. The CU 103 may be configured to handle user plane functionality (i.e., Central Unit-User Plane (CU-UP)), control plane functionality (i.e., Central Unit-Control Plane (CU-CP)), or a combination thereof. In some implementations, the CU 103 can be logically split into one or more CU-UP units and one or more CU-CP units. The CU-UP unit can communicate bidirectionally with the CU-CP unit via an interface, such as the E1 interface when implemented in an O-RAN configuration. The CU 103 can be implemented to communicate with the DU 113, as necessary, for network control and signaling.

The DU 113 may correspond to a logical unit that includes one or more base station functions to control the operation of one or more RUs 115. In some aspects, the DU 113 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 113 may further host one or more low PHY layers. Each layer (or module) can be implemented with an interface configured to communicate signals with other layers (and modules) hosted by the DU 113, or with the control functions hosted by the CU 103.

Lower-layer functionality can be implemented by one or more RUs 115. In some deployments, an RU 115, controlled by a DU 113, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 115 can be implemented to handle over the air (OTA) communication with one or more UEs 104. In some implementations, real-time and non-real-time aspects of control and user plane communication with the RU(s) 115 can be controlled by the corresponding DU 113. In some scenarios, this configuration can enable the DU(s) 113 and the CU 103 to be implemented in a cloud-based RAN architecture, such as a vRAN architecture.

The SMO Framework 111 may be configured to support RAN deployment and provisioning of non-virtualized and virtualized network elements. For non-virtualized network elements, the SMO Framework 111 may be configured to support the deployment of dedicated physical resources for RAN coverage requirements which may be managed via an operations and maintenance interface (such as an O1 interface). For virtualized network elements, the SMO Framework 111 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 103, DUs 113, RUs 115 and Near-RT RICs 107. In some implementations, the SMO Framework 111 can communicate with a hardware aspect of a 4G RAN, such as an open eNB (O-eNB) 117, via an O1 interface. Additionally, in some implementations, the SMO Framework 111 can communicate directly with one or more RUs 115 via an O1 interface. The SMO Framework 111 also may include a

Non-RT RIC 109 configured to support functionality of the SMO Framework 111. The Non-RT RIC 109 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 107. The Non-RT RIC 109 may be coupled to or communicate with (such as via an A1 interface) the Near-RT RIC 107. The Near-RT RIC 107 may be configured to include a logical function that enables near-real-time control and optimization of RAN elements and resources via data collection and actions over an interface (such as via an E2 interface) connecting one or more CUs 103, one or more DUs 113, or both, as well as an O-eNB, with the Near-RT RIC 107.

In some implementations, to generate AI/ML models to be deployed in the Near-RT RIC 107, the Non-RT RIC 109 may receive parameters or external enrichment information from external servers. Such information may be utilized by the Near-RT RIC 107 and may be received at the SMO Framework 111 or the Non-RT RIC 109 from non-network data sources or from network functions. In some examples, the Non-RT RIC 109 or the Near-RT RIC 107 may be configured to tune RAN behavior or performance. For example, the Non-RT RIC 109 may monitor long-term trends and patterns for performance and employ AI/ML models to perform corrective actions through the SMO Framework 111 (such as reconfiguration via O1) or via creation of RAN management policies (such as A1 policies).

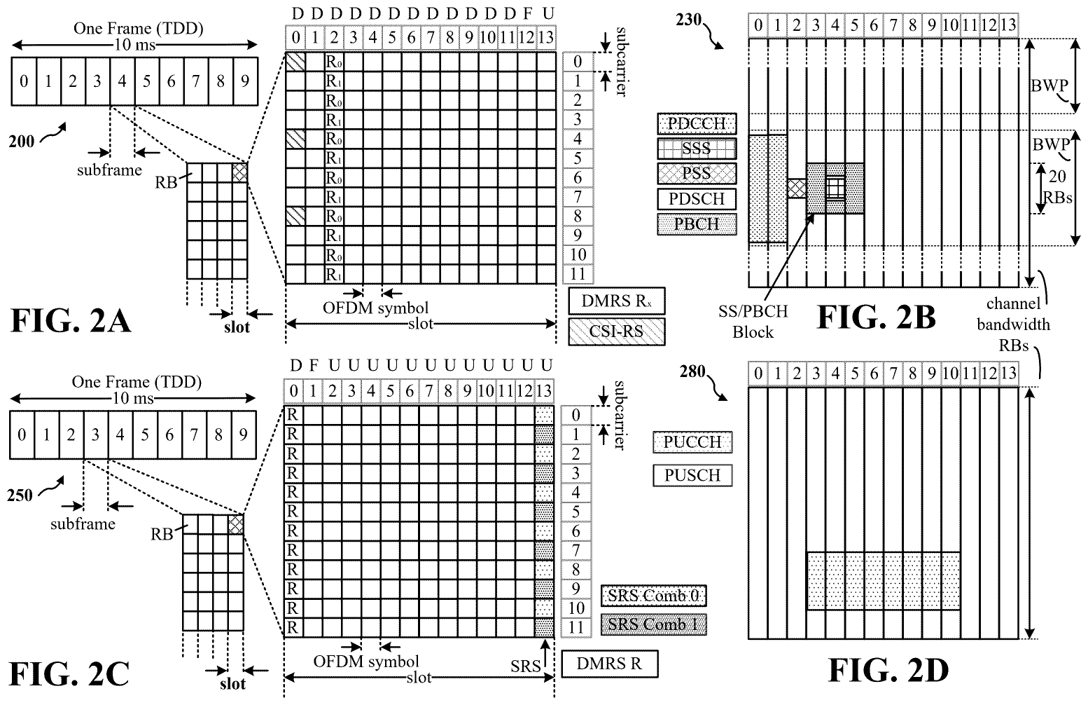

FIGS. 2A-2D are diagrams of various frame structures, resources, and channels used by UEs 104 and base stations 102/180 for communication. FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

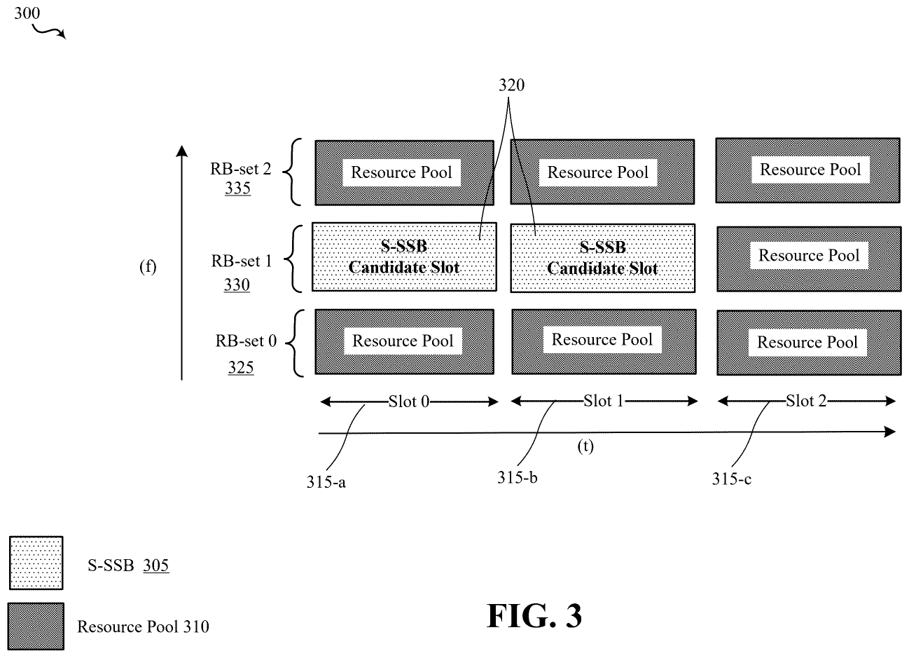

FIG. 3 illustrates a diagram of frame structure, resources, and channels that support the use of an S-SSB waveform in configuration with wideband resource pool (e.g., 100 MHz) in order to reduce and/or minimize S-SSB slot avoidance and increase and/or maximize resource pool utilization. As noted above, wireless communications system may be an example of a 5G NR system, and may support wireless devices establishing an access link (e.g., a Uu interface) and/or a sidelink (e.g., a PC5 interface). For example, a UE 104 may establish an access link with a network entity 102/108 and a sidelink (e.g., a sidelink communication link) with another UE 104. In some cases, a UE 104 may establish an access link with a network entity 102/108 and may establish a sidelink with another UE 104 which operates as a relay (e.g., which has an access link with the same or different network entity 102/108 as the UE 104) such that the UE 104 may communicate with a network via either the access link, or the sidelink, or both. In some cases, devices may use a sidelink to extend a coverage area. For example, a UE 104 may establish a sidelink with another UE 104 (e.g., a relay UE) having an access link with a network entity 102/108 for which the UE 104 is out of coverage. Sidelink communications may be referred to as vehicle-to-vehicle (V2V) communications, V2X communications, device-to-device (D2D) communications, or other terminology.

The wireless communications system may also support sidelink communications in shared radio frequency spectrum bands (e.g., unlicensed radio frequency spectrum bands), which may not be reserved, allocated, or licensed for specific use cases or specific RATs. The UE 104 may perform one or more channel access procedures to gain access to the one or more unlicensed frequency bands. As an example, a UE 104 may communicate using time-frequency resources after gaining access to a channel using one or more channel access techniques (e.g., LBT) to reserve resources for transmitting a signal. Upon gaining access to the shared spectrum, the UE 104 may transmit signaling using a number of symbol periods (e.g., OFDM symbol periods) within a slot, which may be an example of a TTI (e.g., slots or time slots).

In some examples, a first UE 104-a may transmit information to a second UE 104-b, over a communication link, which may be an example of a sidelink (e.g., a D2D communication link). The first UE 104-a may transmit (e.g., periodically) one or more S-SSBs 305, which may facilitate synchronization of communications between multiple UEs 104. Conversely the UE 115-b may receive the one or more S-SSB 305 and perform one or more operations to synchronize time-frequency resources with the UE 115-a. In some cases, the S-SSB 305 may include a primary synchronization signal (PSS) and a secondary synchronization signal (SSS). A UE 104 may transmit the one or more S-SSB 305 using multicast, groupcast, or broadcast signaling.

In some examples, the UE 104 may use some techniques for transmitting S-SSBs such that the S-SSB occupies a full slot (e.g., Slot 0). In other instances, the UE 104 may be unable to multiplex the S-SSB with other transmissions because the S-SSB structure (e.g., waveform) may not match a resource pool structure associated with other transmission types (e.g., a resource pool structure for PSCCH and PSSCH transmissions). Further, the S-SSB may be incompatible with one or more resource configurations (e.g., a sub-channel-based resource pool configuration).

Accordingly, in such instance, the S-SSB 305 may occupy a portion of the slot (e.g., first slot 315-a). In conventional systems, the UEs would be forced to omit transmitting on a slot (e.g., first slot 315-a) that includes S-SSB 305, and therefore potentially waste bandwidth resources. The negative impact of S-SSB slot avoidance is aggravated further because the DRS window may include multiple S-SSB candidate locations to increase opportunities for the UE to transmit S-SSB 305.

In accordance with the techniques described herein, a UE may transmit one or more S-SSBs 305 in S-SSB candidate slot(s) 320 within one or more sub-band(s) (e.g., first sub-band 325 associated with RB-set 0, second sub-band 330 associated with RB-set 1, and/or third sub-band 335 associated with RB-set 2) such that the remaining bandwidth, including within the same slot as the S-SSB remain available in the resource pool for data communication. In some examples, the sidelink-unlicensed band may be configured with wideband operation (e.g., 100 MHz). As such, the exclusion of all RB-sets in S-SSB slot from resource pool may be avoided by the UEs.

Thus, in the illustrated example, a first S-SSB candidate slot 320 and second S-SSB candidate slot 320 may be allocated for a second sub-band 330 (e.g., RB-set 1) in the first slot 315-a (Slot 0) or second slot 315-b (Slot 1). The wideband resource pool 310 may be configured to select from the non S-SSB occupying RB-sets (e.g., RB-set 0 and RB-set 2 in the first slot 315-a and the second slot 315-b, and RB-set 0, RB-set 1, RB-set 2 for the third slot 315-c). In such instance, the resource pool 310 may avoid the particular one or more sub-bands for the S-SSB candidate RB-set(s), while allowing the resource pool configuration to select from the remaining available RB-set(s) for data communication. Such implementation reduces the S-SSB overhead associated with resource management compared to conventional systems because fewer sub-bands are omitted from the resource pool.

In some cases, the UE may transmit sidelink control information (SCI), which may indicate which sub-bands are carrying the S-SSBs. The SCI may indicate the one or more sub-bands via a bitmap, a sub-band index field, a single bit, or any combination thereof. The SCI reservation signaling may allow full flexibility of sub-channel (in terms of RB-set and interlace) reservation.

As the slots (e.g., 315-a and/or 315-b) that may include the S-SSB signal in one or more S-SSB candidate slots 320 are included in the resource pool, one or more additional UEs 104 (e.g., SL-U node) may signal subchannel reservation on the S-SSB candidate RB-set (e.g., RB-set 1 in second sub-band 330). In such an instance, if the SCI reservation references the S-SSB candidate RB-sets in the S-SSB slot, the transmitting UE may ignore the resource reservation request. The resource selection may select only resources within the resource pool 310 such that any reservations for resources outside of the resource pool 310 may be considered invalid. In such instance, if the UE transmits the S-SSB 305, the UE may transmit the S-SSB without considering the reservation request from another UE for resources that collide with the SSB candidate RB-sets.

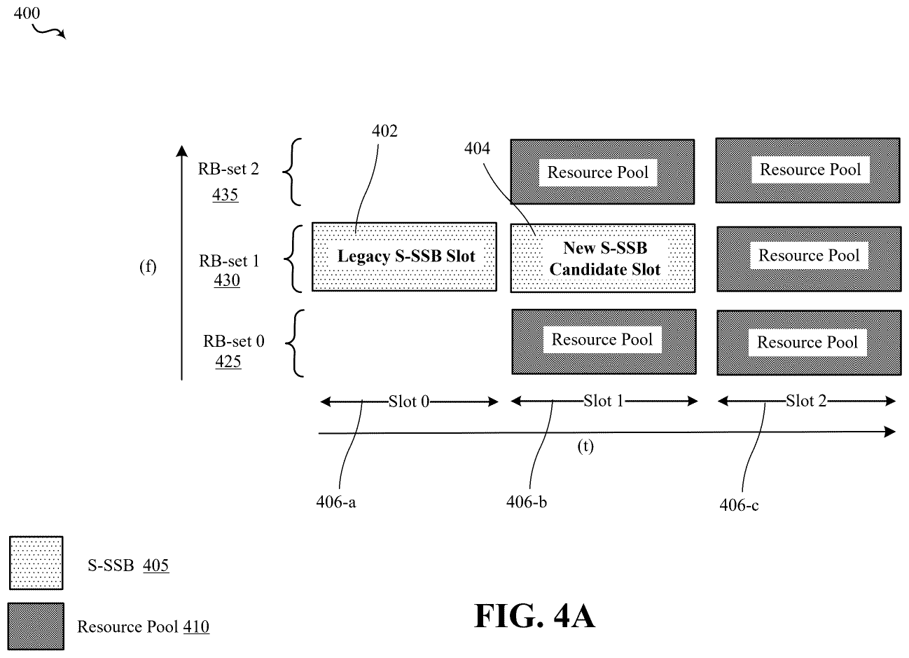

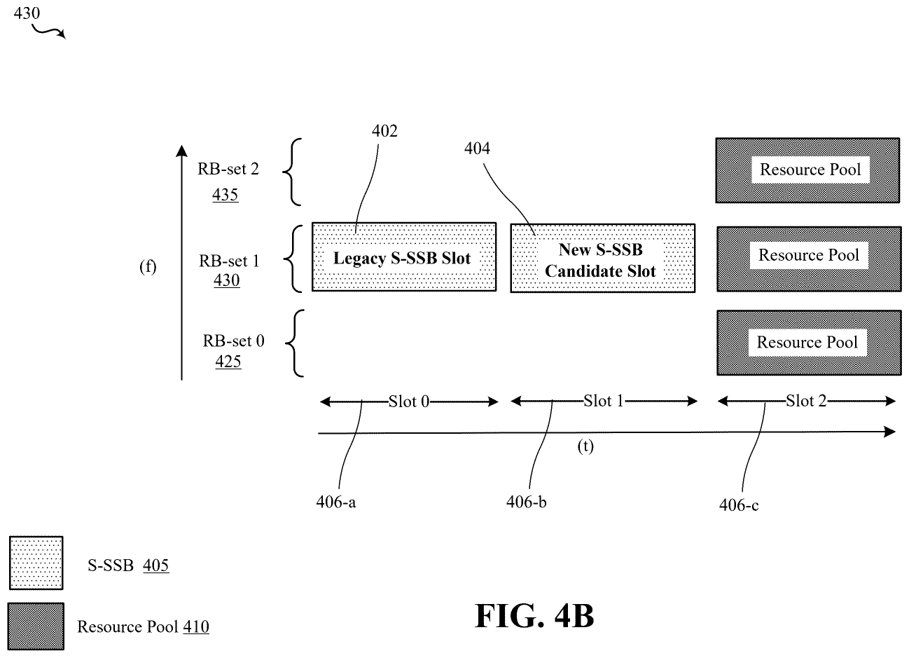

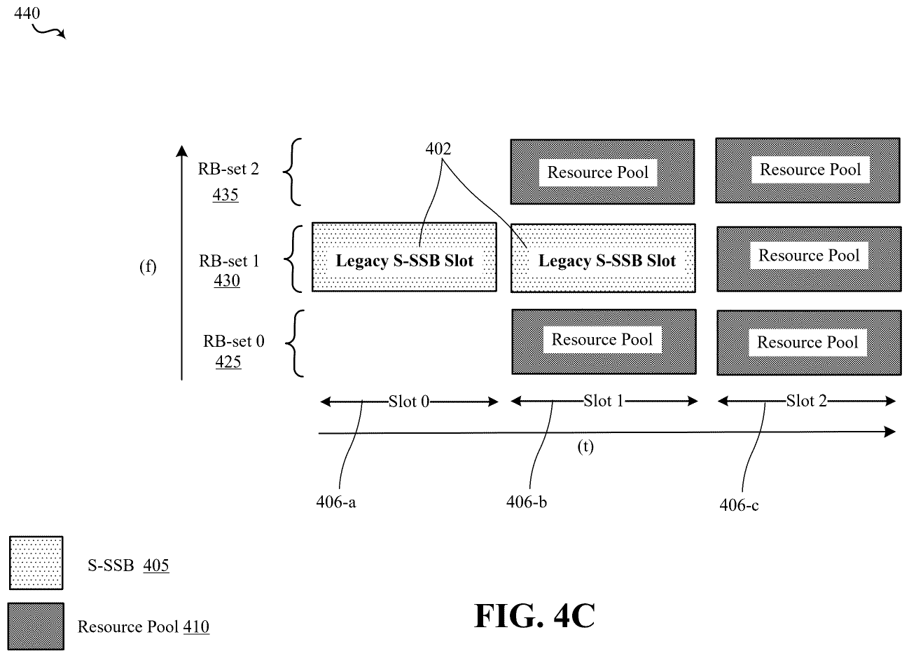

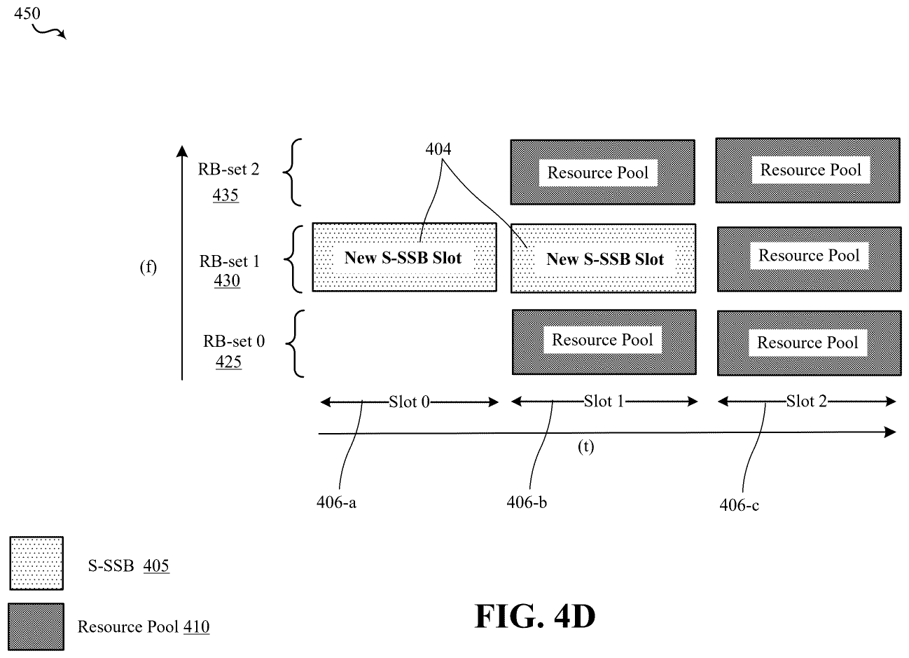

FIGS. 4A-4E are additional diagrams of frame structure, resources, and channels that support the use of an S-SSB waveform in configuration with wideband resource pool in order to reduce and/or minimize S-SSB slot avoidance and to increase and/or maximize resource pool utilization. In some instances, the resource bandwidth may include both legacy S-SSB candidate slots 402 and new S-SSB candidate slots 404 (e.g., additional slots for more LBT opportunities) for transmissions of S-SSB in the wideband resource pool. In such instances, the wireless communication system and the UEs may be configured such that one or both of slots (first slot 406-a, second slot 406-b) associated with legacy S-SSB candidate slots 402 and/or new S-SSB candidate slots 404 may be excluded from the wideband resource pool.

For example, as illustrated in FIG. 4A, the wireless communication system and the UEs may be configured with both legacy S-SSB candidate slots 402 (e.g., first S-SSB candidate slot) and new S-SSB candidate slots 404 (e.g., second S-SSB candidate slot) to be transmitted in the second sub-band (e.g., RB-set 1) in corresponding the first slot 406-a and second slot 406-b. In some instances (e.g., in order to be backward compatible), the UEs may be configured to exclude the entire RB sets (e.g., first RB-set 425, second RB-set 430, and third RB-set 435) corresponding to each sub-band within the first slot 406-a that includes a legacy S-SSB candidate slot 402 (e.g., first S-SSB candidate slot). However, with respect to the new S-SSB candidate slots 404, the RB sets (e.g., first RB-set 425 and third RB-set 435) corresponding to first sub-band and third sub-band 435 sub-bands within the second slot 406-b may still be included within the resource pool 410. Thus, while providing backward compatibility and extended flexibility, such implementation would still minimize the omission of valuable resources for data communication. And because legacy S-SSB candidate slots 404 may occur infrequency (e.g., once or twice per 160 ms for SCS of 15 and 30 KHz), excluding the limited number of resources in such instance may reduce or limit the adverse impact to the S-SSB overhead.

However, in other instances such as those illustrated in FIG. 4B, RB-sets (e.g., first RB-set 425 and third RB-set 435 corresponding to first and third sub-bands) within the first time slot 406-a and second time slot 406-b may also be excluded from the resource pool for both legacy S-SSB candidate slots 402 (e.g., first S-SSB candidate slot) and new S-SSB candidate slots 404 (e.g., second S-SSB candidate slot).

In yet other instances, as those illustrated in FIG. 4C, the wireless communication system and the UEs may be configured for multiple legacy S-SSB candidate slots 402 (e.g., first S-SSB candidate slots). For example, in the first time slot 406-a and the second time slot 406-b, the second sub-band 430 associated with the RB-set 1 may be allocated for legacy S-SSB candidate slots 402 for transmissions of S-SSBs. In such instance, the first sub-band 425 and third sub-band 430 for at least first time slot 406-a may be omitted from the resource pool due to the presence of legacy S-SSB candidate slot 402 in the second sub-band 430 within the first time slot 406-a. However, for the second time slot 406-b, the first sub-band 425 and third sub-band 430 may be included within the resource pool 410 despite the presence of the legacy S-SSB candidate slot 402 in the second sub-band 430 of the second time slot 406-b. In other words, the wireless communication system and the UEs may be configured to exclude portion of the RB-sets in one time slot while maintaining the RB-sets in the resource pool for a different time slot.

Similarly, as illustrated in FIG. 4D, the wireless communication system and the UEs may be configured for multiple new S-SSB candidate slots 404 (e.g., second S-SSB candidate slots). For example, in the first time slot 406-a and the second time slot 406-b, the second sub-band 430 associated with the RB-set 1 may be allocated for new S-SSB candidate slots 404 for transmissions of S-SSBs. In such instance, the first sub-band 425 and third sub-band 430 for at least first time slot 406-a may be omitted from the resource pool due to the presence of new S-SSB candidate slot 404 in the second sub-band 430 within the first time slot 406-a. However, for the second time slot 406-b, the first sub-band 425 and third sub-band 430 may be included within the resource pool 410 despite the presence of the new S-SSB candidate slot 404 in the second sub-band 430 of the second time slot 406-b.

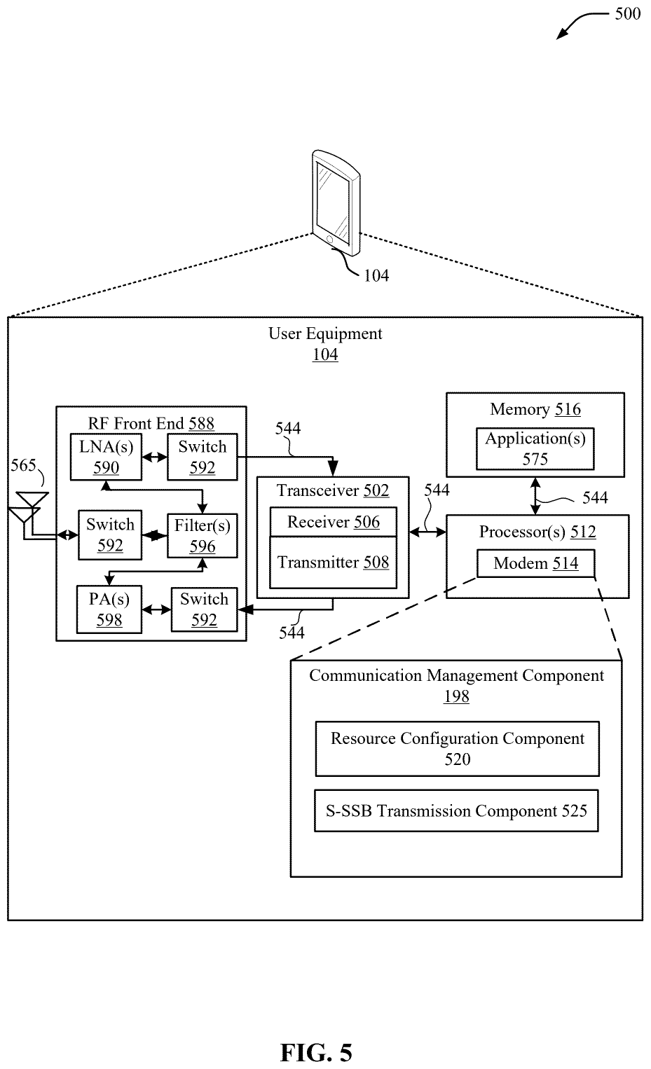

FIG. 5 illustrates a hardware components and subcomponents of a device that may be a UE 104 for implementing one or more methods (e.g., method 600) described herein in accordance with various aspects of the present disclosure. The UE 104 may be an example of UE 104 disclosed with reference to FIG. 1A. For example, one example of an implementation of the UE 104 may include a variety of components, some of which have already been described above, but including components such as one or more processors 512, memory 516 and transceiver 502 in communication via one or more buses 544, which may operate in conjunction with the communication management component 198 to perform functions described herein related to including one or more methods (e.g., 600) of the present disclosure.

Particularly, the communication management component 198 may include a resource configuration component 520 for configuring and selecting the resource pool for data communications to account for S-SSB transmission rom the UE. The communication management component 198 may also include a S-SSB transmission component 525 for transmitting S-SSB within one or more resources in accordance with aspects of the present disclosure.

The one or more processors 512, modem 514, memory 516, transceiver 502, RF front end 588 and one or more antennas 565, may be configured to support voice and/or data calls (simultaneously or non-simultaneously) in one or more radio access technologies. In an aspect, the one or more processors 512 can include a modem 514 that uses one or more modem processors. The various functions related to communication management component 198 may be included in modem 514 and/or processors 512 and, in an aspect, can be executed by a single processor, while in other aspects, different ones of the functions may be executed by a combination of two or more different processors. For example, in an aspect, the one or more processors 512 may include any one or any combination of a modem processor, or a baseband processor, or a digital signal processor, or a transmit processor, or a receiver processor, or a transceiver processor associated with transceiver 502. In other aspects, some of the features of the one or more processors 512 and/or modem 514 associated with communication management component 198 may be performed by transceiver

The memory 516 may be configured to store data used herein and/or local versions of application(s) 575 or communication management component 198 and/or one or more of its subcomponents being executed by at least one processor 512. The memory 516 can include any type of computer-readable medium usable by a computer or at least one processor 512, such as random access memory (RAM), read only memory (ROM), tapes, magnetic discs, optical discs, volatile memory, non-volatile memory, and any combination thereof. In an aspect, for example, the memory 516 may be a non-transitory computer-readable storage medium that stores one or more computer-executable codes defining communication management component 198 and/or one or more of its subcomponents, and/or data associated therewith, when the UE 104 is operating at least one processor 512 to execute communication management component 198 and/or one or more of its subcomponents.

The transceiver 502 may include at least one receiver 506 and at least one transmitter 508. The receiver 506 may include hardware, firmware, and/or software code executable by a processor for receiving data, the code comprising instructions and being stored in a memory (e.g., computer-readable medium). The receiver 506 may be, for example, a radio frequency (RF) receiver. In an aspect, the receiver 506 may receive signals transmitted by at least one UE 104. Additionally, receiver 506 may process such received signals, and also may obtain measurements of the signals, such as, but not limited to, Ec/Io, SNR, RSRP, RSSI, etc. The transmitter 508 may include hardware, firmware, and/or software code executable by a processor for transmitting data, the code comprising instructions and being stored in a memory (e.g., computer-readable medium). A suitable example of the transmitter 508 may including, but is not limited to, an RF transmitter.

Moreover, in an aspect, transmitting device may include the RF front end 588, which may operate in communication with one or more antennas 565 and transceiver 502 for receiving and transmitting radio transmissions, for example, wireless communications transmitted by at least one base station 102 or wireless transmissions transmitted by UE 104. The RF front end 588 may be connected to one or more antennas 565 and can include one or more low-noise amplifiers (LNAs) 590, one or more switches 592, one or more power amplifiers (PAs) 598, and one or more filters 596 for transmitting and receiving RF signals.

In an aspect, the LNA 590 can amplify a received signal at a desired output level. In an aspect, each LNA 590 may have a specified minimum and maximum gain values. In an aspect, the RF front end 588 may use one or more switches 592 to select a particular LNA 590 and its specified gain value based on a desired gain value for a particular application.

Further, for example, one or more PA(s) 598 may be used by the RF front end 588 to amplify a signal for an RF output at a desired output power level. In an aspect, each PA 598 may have specified minimum and maximum gain values. In an aspect, the RF front end 588 may use one or more switches 592 to select a particular PA 598 and its specified gain value based on a desired gain value for a particular application.

Also, for example, one or more filters 596 can be used by the RF front end 458 to filter a received signal to obtain an input RF signal. Similarly, in an aspect, for example, a respective filter 596 can be used to filter an output from a respective PA 598 to produce an output signal for transmission. In an aspect, each filter 496 can be connected to a specific LNA 590 and/or PA 598. In an aspect, the RF front end 588 can use one or more switches 592 to select a transmit or receive path using a specified filter 596, LNA 590, and/or PA 598, based on a configuration as specified by the transceiver 502 and/or processor 512.

As such, the transceiver 502 may be configured to transmit and receive wireless signals through one or more antennas 565 via the RF front end 588. In an aspect, the transceiver 502 may be tuned to operate at specified frequencies such that transmitting device can communicate with, for example, one or more base stations 102 or one or more cells associated with one or more base stations 102 or other UEs 104. In an aspect, for example, the modem 514 can configure the transceiver 502 to operate at a specified frequency and power level based on the configuration of the transmitting device and the communication protocol used by the modem 514.

In an aspect, the modem 514 can be a multiband-multimode modem, which can process digital data and communicate with the transceiver 502 such that the digital data is sent and received using the transceiver 502. In an aspect, the modem 514 can be multiband and be configured to support multiple frequency bands for a specific communications protocol. In an aspect, the modem 514 can be multimode and be configured to support multiple operating networks and communications protocols. In an aspect, the modem 514 can control one or more components of transmitting device (e.g., RF front end 588, transceiver 502) to enable transmission and/or reception of signals from the network based on a specified modem configuration. In an aspect, the modem configuration can be based on the mode of the modem 514 and the frequency band in use. In another aspect, the modem configuration can be based on UE configuration information associated with transmitting device as provided by the network during cell selection and/or cell reselection.

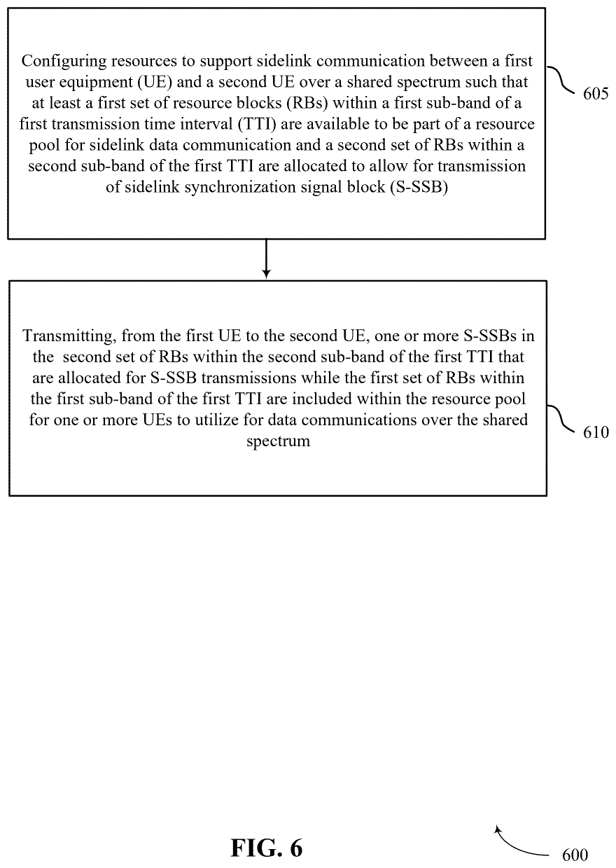

Referring to FIG. 6, an example method 600 for wireless communications in accordance with aspects of the present disclosure may be performed by one or more UEs 104 discussed with reference to FIGS. 1A. Although the method 600 is described below with respect to the elements of the UE 104, other components may be used to implement one or more of the steps described herein.

At block 605, the method 600 may include configuring resources to support sidelink communication between a first UE and a second UE over a shared spectrum such that at least a first set of RBs within a first sub-band of a first TTI (e.g., slots) are available to be part of a resource pool for sidelink data communication and a second set of RBs within a second sub-band of the first TTI are allocated to allow for transmission of S-SSB.

In some aspects, the resource pool may omit the second set of RBs within the first TTI allocated for transmission of S-SSB. In some examples, configuring resources to support sidelink communication includes a first S-SSB candidate slot within at least one sub-band of a first TTI and a second S-SSB candidate slot within the at least one sub-band of a second TTI. The first S-SSB candidate slots may be part of a default number of S-SSB candidate slot (e.g., legacy S-SSB candidate slot) allocations and the second S-SSB candidate slots (e.g., new S-SSB candidate slots) may be additional candidate slots to support listen-before-talk (LBT) procedure beyond the default number of S-SSB candidate slots.

In some aspects, the first S-SSB candidate slots and the second S-SSB candidate slots may be part of a default number of S-SSB candidate slot allocations. In other instances, the first S-SSB candidate slots and the second S-SSB candidate slots may be an additional candidate slots to support LBT procedure. In some instances, the resource pool may omit all RBs in one of the first TTI corresponding to the first S-SSB candidate slot or the second TTI corresponding to the second S-SSB candidate slot. In other instances, the resource pool may omit all RBs in both of the first TTI corresponding to the first S-SSB candidate slot and the second TTI corresponding to the second S-SSB candidate slot.

In yet another example, the resource pool may omit at least a portion of RBs in one of the first TTI corresponding to the first S-SSB candidate slot or the second TTI corresponding to the second S-SSB candidate slot. In such scenario, the first S-SSB candidate slots and second S-SSB candidate slot may be either both part of a default number of S-SSB candidate slot allocations or additional candidate slots to support LBT procedure.

The method may also include transmitting a sidelink control information (SCI) message indicating which of the one or more sub-bands include the one or more the S-SSBs. The SCI message may comprise a bitmap indicating which of the one or more sub-bands include the one or more S-SSBs. The method may also include receiving, at the first UE, a SCI message from a third UE indicating that the third UE has selected the second set of RBs within the second sub-band of the first TTI outside of the resource pool for data communication, and ignoring a resource reservation request from the third UE based on a determination that resource selection is outside of the resource pool. In some examples, the processor 512, the modem 514, the communication management component 198, the resource configuration component 520 in and/or one or more other components or subcomponents of the UE 104 may perform the method of block 605.

In certain implementations, the processor 512, the modem 514, the communication management component 198, the resource configuration component 520 in and/or one or more other components or subcomponents of the UE 104 may be configured to and/or may define means for configuring resources to support sidelink communication between a first UE and a second UE over a shared spectrum such that at least a first set of RBs within a first sub-band of a first TTI are available to be part of a resource pool for sidelink data communication and a second set of RBs within a second sub-band of the first TTI are allocated to allow for transmission of S-SSB.

At block 610, the method 600 may include transmitting, from the first UE to the second UE, one or more S-SSBs in the second set of RBs within the second sub-band of the first TTI that are allocated for S-SSB transmissions while the first set of RBs within the first sub-band of the first TTI are included within the resource pool for one or more UEs to utilize for data communications over the shared spectrum. In some examples, the processor 512, the modem 514, the communication management component 198, the S-SSB transmission component 525 in conjunction with the transceiver 502 and/or one or more other components or subcomponents of the UE 104 may perform the method of block 610.

In certain implementations, the processor 512, the modem 514, the communication management component 198, the S-SSB transmission component 525 in conjunction with the transceiver 502 and/or one or more other components or subcomponents of the UE 104 may be configured to and/or may define means for transmitting, from the first UE to the second UE, one or more S-SSBs in the second set of RBs within the second sub-band of the first TTI that are allocated for S-SSB transmissions while the first set of RBs within the first sub-band of the first TTI are included within the resource pool for one or more UEs to utilize for data communications over the shared spectrum.

### Some Further Example Clauses

Implementation examples are described in the following numbered clauses:
1. A method for wireless communications, comprising:
   configuring resources to support sidelink communication between a first user equipment (UE) and a second UE over a shared spectrum such that at least a first set of resource blocks (RBs) within a first sub-band of a first transmission time interval (TTI) are available to be part of a resource pool for sidelink data communication and a second set of RBs within a second sub-band of the first TTI are allocated to allow for transmission of sidelink synchronization signal block (S-SSB); and
   transmitting, from the first UE to the second UE, one or more S-SSBs in the second set of RBs within the second sub-band of the first TTI that are allocated for S-SSB transmissions while the first set of RBs within the first sub-band of the first TTI are included within the resource pool for one or more UEs to utilize for data communications over the shared spectrum.
2. The method of clause 1, wherein the resource pool omits the second set of RBs within the first TTI allocated for transmission of S-SSB.
3. The method of clause 1-2, further comprising:
   transmitting a sidelink control information (SCI) message indicating which of the one or more sub-bands include the one or more the S-SSBs.
4. The method of clause 1-3, wherein the sidelink control information message comprises a bitmap indicating which of the one or more sub-bands include the one or more S-SSBs.
5. The method of any of the preceding clauses, further comprising:
   receiving, at the first UE, a sidelink control information (SCI) message from a third UE indicating that the third UE has selected the second set of RBs within the second sub-band of the first TTI outside of the resource pool for data communication; and
   ignoring a resource reservation request from the third UE based on a determination that resource selection is outside of the resource pool.
6. The method of any of the clauses 1-5, wherein configuring resources to support sidelink communication includes a first S-SSB candidate slot within at least one sub-band of a first TTI and a second S-SSB candidate slot within the at least one sub-band of a second TTI.
7. The method of any of the clauses 1-6, wherein the first S-SSB candidate slots is part of a default number of S-SSB candidate slot allocations and the second S-SSB candidate slots are an additional candidate slots to support listen-before-talk (LBT) procedure.
8. The method of any of the clauses 1-6, wherein the first S-SSB candidate slots and the second S-SSB candidate slots are part of a default number of S-SSB candidate slot allocations.
9. The method of any of the clauses 1-6, wherein the first S-SSB candidate slots and the second S-SSB candidate slots are an additional candidate slots to support listen-before-talk (LBT) procedure
10. The method of any of the clauses 1-6, wherein the resource pool omits all RBs in one of the first TTI corresponding to the first S-SSB candidate slot or the second TTI corresponding to the second S-SSB candidate slot.
11. The method of any of the clauses 1-6, wherein the resource pool omits all RBs in both of the first TTI corresponding to the first S-SSB candidate slot and the second TTI corresponding to the second S-SSB candidate slot.
12. The method of any of the clauses 1-6, wherein the resource pool omits at least a portion of RBs in one of the first TTI corresponding to the first S-SSB candidate slot or the second TTI corresponding to the second S-SSB candidate slot.
13. The method of any of the clauses 1-6 and 12, wherein the first S-SSB candidate slots and second S-SSB candidate slot are either both part of a default number of S-SSB candidate slot allocations or additional candidate slots to support listen-before-talk (LBT) procedure.
14. An apparatus for wireless communication by a first user equipment (UE), comprising:
   a memory; and
   a processor coupled with the memory and configured to:
   configure resources to support sidelink communication between the first UE and a second UE over a shared spectrum such that at least a first set of resource blocks (RBs) within a first sub-band of a first transmission time interval (TTI) are available to be part of a resource pool for sidelink data communication and a second set of RBs within a second sub-band of the first TTI are allocated to allow for transmission of sidelink synchronization signal block (S-SSB); and
   transmit, from the first UE to the second UE, one or more S-SSBs in the second set of RBs within the second sub-band of the first TTI that are allocated for S-SSB transmissions while the first set of RBs within the first sub-band of the first TTI are included within the resource pool for one or more UEs to utilize for data communications over the shared spectrum.
15. The apparatus for wireless communication of clause 14, wherein the resource pool omits the second set of RBs within the first TTI allocated for transmission of S-SSB.
16. The apparatus for wireless communication of clauses 14 or 15, the processor further configured to:
   transmit a sidelink control information (SCI) message indicating which of the one or more sub-bands include the one or more the S-SSBs.
17. The apparatus for wireless communication of any of the preceding clauses, wherein the sidelink control information message comprises a bitmap indicating which of the one or more sub-bands include the one or more S-SSBs.
18. The apparatus for wireless communication of any of the preceding clauses, the processor further configured to:
   receive, at the first UE, a sidelink control information (SCI) message from a third UE indicating that the third UE has selected the second set of RBs within the second sub-band of the first TTI outside of the resource pool for data communication; and
   ignore a resource reservation request from the third UE based on a determination that resource selection is outside of the resource pool.
19. The apparatus for wireless communication of any of the preceding clauses, wherein configuring resources to support sidelink communication includes a first S-SSB candidate slot within at least one sub-band of a first TTI and a second S-SSB candidate slot within the at least one sub-band of a second TTI.
20. A non-transitory computer readable medium storing instructions, executable by a processor, for wireless communications, comprising instructions for:
   configuring resources to support sidelink communication between a first user equipment (UE) and a second UE over a shared spectrum such that at least a first set of resource blocks (RBs) within a first sub-band of a first transmission time interval (TTI) are available to be part of a resource pool for sidelink data communication and a second set of RBs within a second sub-band of the first TTI are allocated to allow for transmission of sidelink synchronization signal block (S-SSB); and
   transmitting, from the first UE to the second UE, one or more S-SSBs in the second set of RBs within the second sub-band of the first TTI that are allocated for S-SSB transmissions while the first set of RBs within the first sub-band of the first TTI are included within the resource pool for one or more UEs to utilize for data communications over the shared spectrum.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method for wireless communication, comprising:
configuring resources to support sidelink communication between a first user equipment (UE) and a second UE over a shared spectrum such that at least a first set of resource blocks (RBs) within a first sub-band of a first transmission time interval (TTI) are available to be part of a resource pool for sidelink data communication and a second set of RBs within a second sub-band of the first TTI are allocated to allow for transmission of sidelink synchronization signal block (S-SSB); and
transmitting, from the first UE to the second UE, one or more S-SSBs in the second set of RBs within the second sub-band of the first TTI that are allocated for S-SSB transmissions while the first set of RBs within the first sub-band of the first TTI are included within the resource pool for one or more UEs to utilize for data communications over the shared spectrum.

2. The method of claim 1, wherein the resource pool omits the second set of RBs within the first TTI allocated for transmission of S-SSB.

3. The method of claim 1, further comprising:
transmitting a sidelink control information (SCI) message indicating which of the one or more sub-bands include the one or more the S-SSBs.

4. The method of claim 3, wherein the SCI message comprises a bitmap indicating which of the one or more sub-bands include the one or more S-SSBs.

5. The method of claim 1, further comprising:
receiving, at the first UE, a sidelink control information (SCI) message from a third UE indicating that the third UE has selected the second set of RBs within the second sub-band of the first TTI outside of the resource pool for data communication; and
ignoring a resource reservation request from the third UE based on a determination that resource selection is outside of the resource pool.

6. The method of claim 1, wherein configuring resources to support sidelink communication includes a first S-SSB candidate slot within at least one sub-band of a first TTI and a second S-SSB candidate slot within the at least one sub-band of a second TTI.

7. The method of claim 6, wherein the first S-SSB candidate slots is part of a default number of S-SSB candidate slot allocations and the second S-SSB candidate slots are an additional candidate slots to support listen-before-talk (LBT) procedure.

8. The method of claim 6, wherein the first S-SSB candidate slots and the second S-SSB candidate slots are part of a default number of S-SSB candidate slot allocations.

9. The method of claim 6, wherein the first S-SSB candidate slots and the second S-SSB candidate slots are an additional candidate slots to support listen-before-talk (LBT) procedure.

10. The method of claim 6, wherein the resource pool omits all RBs in one of the first TTI corresponding to the first S-SSB candidate slot or the second TTI corresponding to the second S-SSB candidate slot.

11. The method of claim 6, wherein the resource pool omits all RBs in both of the first TTI corresponding to the first S-SSB candidate slot and the second TTI corresponding to the second S-SSB candidate slot.

12. The method of claim 6, wherein the resource pool omits at least a portion of RBs in one of the first TTI corresponding to the first S-SSB candidate slot or the second TTI corresponding to the second S-SSB candidate slot.

13. The method of claim 12, wherein the first S-SSB candidate slots and second S-SSB candidate slot are either both part of a default number of S-SSB candidate slot allocations or additional candidate slots to support listen-before-talk (LBT) procedure.

14. An apparatus for wireless communication by a first user equipment (UE), comprising:
a memory including instructions; and
a processor coupled with the memory to execute the instructions and configured to:
configure resources to support sidelink communication between the first UE and a second UE over a shared spectrum such that at least a first set of resource blocks (RBs) within a first sub-band of a first transmission time interval (TTI) are available to be part of a resource pool for sidelink data communication and a second set of RBs within a second sub-band of the first TTI are allocated to allow for transmission of sidelink synchronization signal block (S-SSB); and
transmit, from the first UE to the second UE, one or more S-SSBs in the second set of RBs within the second sub-band of the first TTI that are allocated for S-SSB transmissions while the first set of RBs within the first sub-band of the first TTI are included within the resource pool for one or more UEs to utilize for data communications over the shared spectrum.

15. The apparatus for wireless communication of claim 14, wherein the resource pool omits the second set of RBs within the first TTI allocated for transmission of S-SSB.

16. The apparatus for wireless communication of claim 14, wherein the processor further is configured to:
transmit a sidelink control information (SCI) message indicating which of the one or more sub-bands include the one or more the S-SSBs.

17. The apparatus for wireless communication of claim 16, wherein the SCI message comprises a bitmap indicating which of the one or more sub-bands include the one or more S-SSBs.

18. The apparatus for wireless communication of claim 14, the processor further configured to:
receive, at the first UE, a sidelink control information (SCI) message from a third UE indicating that the third UE has selected the second set of RBs within the second sub-band of the first TTI outside of the resource pool for data communication; and
ignore a resource reservation request from the third UE based on a determination that resource selection is outside of the resource pool.

19. The apparatus for wireless communication of claim 14, wherein configuring resources to support sidelink communication includes a first S-SSB candidate slot within at least one sub-band of a first TTI and a second S-SSB candidate slot within the at least one sub-band of a second TTI.

20. A non-transitory computer readable medium storing instructions, executable by a processor, for wireless communications, comprising instructions for:
configuring resources to support sidelink communication between a first user equipment (UE) and a second UE over a shared spectrum such that at least a first set of resource blocks (RBs) within a first sub-band of a first transmission time interval (TTI) are available to be part of a resource pool for sidelink data communication and a second set of RBs within a second sub-band of the first TTI are allocated to allow for transmission of sidelink synchronization signal block (S-SSB); and
transmitting, from the first UE to the second UE, one or more S-SSBs in the second set of RBs within the second sub-band of the first TTI that are allocated for S-SSB transmissions while the first set of RBs within the first sub-band of the first TTI are included within the resource pool for one or more UEs to utilize for data communications over the shared spectrum.
